(19) United States
(12) Patent Application Publication
(10) Pub. No.: US 2006/0085205 A1
(43) Pub. Date: Apr. 20, 2006

(54) Method, program and system for the implementation of cognitive business processes

(76) Inventor: Sampath Kumar, Alpharetta, GA (US)

Correspondence Address: NEEDLE & ROSENBERG, P.C., SUITE 1000, 999 PEACHTREE STREET, ATLANTA, GA, 30309-3915, US

(21) Appl. No.: 10/961,520

(22) Filed: Oct. 8, 2004

(51) Int. Cl. G06Q 99/00

(52) U.S. Cl. 705/1

(57) ABSTRACT

A cognitive business process (CBP) for use by an enterprise. A knowledge engine and knowledge base are used by an end user when information is received regarding a potential business transaction. The knowledge engine uses the information about the potential business transaction, goals of the business enterprise and knowledge residing within the knowledge base to determine a business context of the business transaction and develop a plan to be implemented by the business enterprise for use at each step of the business transaction. The plan provides suggestions about how to provide value for a prospective business partner and addresses the prospective business partner's needs and objectives at each step of the plan. The plan also considers the needs and objectives of the business enterprise.

### BACKGROUND OF THE INVENTION

1. Field of the Invention

The present invention relates to a technique for adding cognition to business processes at any given step of a business transaction. The present invention provides a method, program and system for providing an end user with human-like decision making, reasoning and learning capabilities to determine the knowledge that would be relevant at each step of the business transaction.

2. Description of the Related Art

Adding value to an Enterprise requires adding business and knowledge management processes to the Enterprise to dynamically improve Enterprise-wide business results and to continuously renew and increase the fundamental value of the Enterprise. These requirements have become quite challenging to senior management within the Enterprise. The business environment is increasing in complexity and uncertainty, and product and industry life cycles are becoming shorter. Moreover, because the business world is more increasingly global, the need for dynamic mass-customized solutions to add value seems to be on the rise.

FIG. 1 illustrates a conventional business process. At step 102, a salesperson in an Enterprise inputs information regarding a potential business transaction, for example, a sale of telecommunications equipment, into a system. At step 104, the system uses the input information and creates an account including contact information for a purchaser that may be involved in the potential business transaction. At step 106, the system generates a plurality of reports, for example, a list of successful sales over a period of time, for the selected account. At step 108, either the system or management personnel for the Enterprise determines if a new sales objective has been identified. At step 110, if a new sales objective has not been identified, the Enterprise is prompted to initiate a new marketing campaign to create additional business. At step 112, if the new sales objective has been identified, the system subsequently creates another new sales objective for the Enterprise.

Business process reengineering (BPR) was an idea that was spawned by academia. Its initial goals were to help Enterprises redesign their business processes and synchronize them with their major priorities. By successfully selling to C-level executives, BPR vendors and management consulting firms created a multi-billion dollar market for their products and services in the 1990s.

Several categories of Enterprise software arose as offshoots of BPR. Examples include Enterprise Resource Planning (ERP) and Customer Relationship Management (CRM). These Enterprise software packages incorporated best practice business processes across broad functional areas. New versions of Enterprise software packages are introduced to a market approximately every two years. However, the inability of current Enterprise software to adapt to changes within the two-year period creates a ridged corporate culture and stifles an Enterprise's flexibility thereby jeopardizing the existence of the Enterprise in an ever changing market. Thus, current Enterprise software fails to improve an Enterprise because it focuses on best practices that will eventually force the Enterprise to become rigid and inflexible and thus, incapable of adapting to rapidly changing business environments.

Value creation in the Enterprise has thus far been predominantly a passive strategy responding to market movements rather than a proactive strategy pervading all functions and occurring throughout the Enterprise by identifying all the opportunities and spaces in which to add value. Value creation is dependent upon strategy, which is inherently a creative process, but business creativity is much broader in that it encompasses both innovation and entrepreneurship.

Current Enterprise software fails to provide an Enterprise with information technology solutions that impart capabilities to leverage and grow knowledge assets of the Enterprise. Current Enterprise software also does not consider the commitment, expertise and innovative inputs from the field nor does it incorporate any links such as marketing research, knowledge bases and on-line expert advice-giving systems.

FIG. 2 illustrates a timeline for functionality in Enterprise business software. In the 1960s and 1970s, when data processing systems entered the business environment, they were leveraged to automate business processes. This entailed using these systems for low-skill, repetitive activities that employees were performing. In the 1980s, 1990s and today, with the emergence of open IT standards and client/server technology, business processes were integrated across broad functional areas. These integrated business processes delivered higher levels of data access and productivity to Enterprises. Accordingly, value creation by an Enterprise is not fully realized since current Enterprise software does not utilize cognition and cannot think, learn and adapt to ever changing situations that occur in a business environment.

### SUMMARY OF THE INVENTION

The present invention provides a method and system for providing an Enterprise with information technology solutions that impart capabilities to leverage and grow knowledge assets of the Enterprise. In a first exemplary embodiment, an end user inputs parameters concerning a particular business transaction into the system. Based on the parameters, needs and objectives of a company (or the Enterprise) and the needs and objectives of an end user for the particular transaction, the system determines a business context of the business transaction and generates an actionable plan for use by the end user. The system utilizes human-like decision-making, reasoning and learning capabilities to determine the knowledge that would be relevant at each step of a business process, which is used in creating the actionable plan for the end user.

In a second exemplary embodiment, an end user inputs parameters concerning a particular sales objective into the system. Based on the parameters, needs and objectives of a buyer and the needs and objectives of the end user for the particular sale, the system computes an actionable plan for use by the end user that is particular to the sales objective. The system utilizes human-like decision making, reasoning and learning capabilities to determine the knowledge that would relevant at each step of the sale, which is used in creating the actionable plan for the end user to complete the sale.

### BRIEF DESCRIPTION OF THE DRAWINGS

The foregoing and other advantages and features of the invention will become more apparent from the detailed description of exemplary embodiments of the invention given below with reference to the accompanying drawings.

FIG. 1 is a flow chart illustrating a conventional business process;

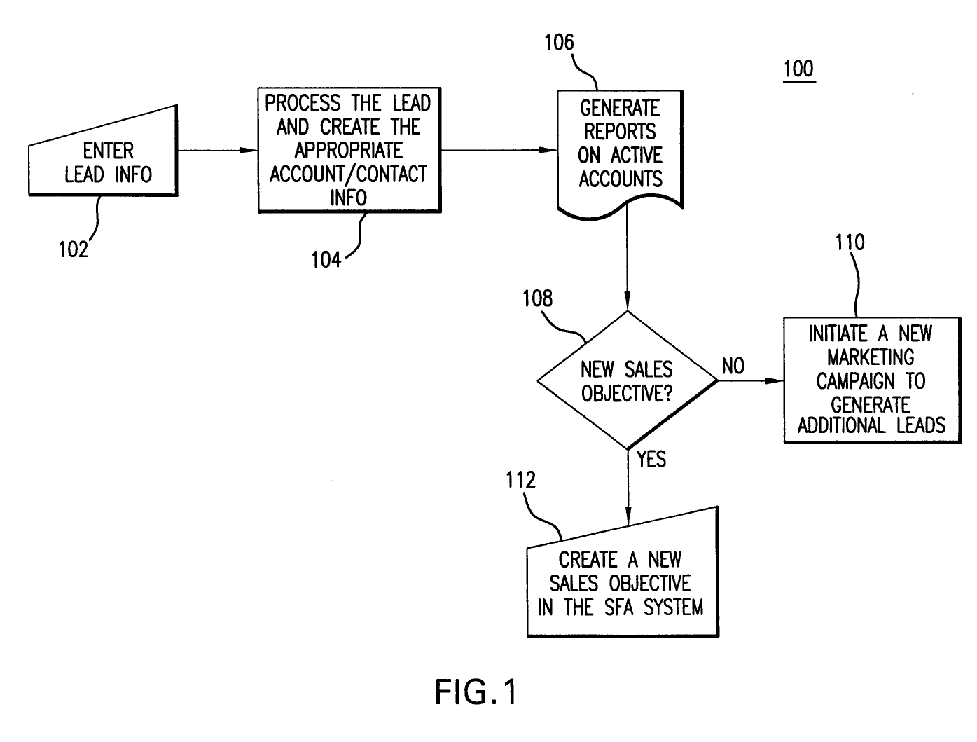

FIG. 2 is a chart illustrating a functionality timeline for Enterprise business software.

FIG. 3 is a flow chart illustrating a first exemplary embodiment of the invention;

FIG. 4 is a flow chart illustrating individual phases of the first exemplary embodiment of the invention;

FIG. 5 is a flow chart illustrating steps implemented by a first phase of FIG. 4;

FIG. 6 is a chart illustrating an integration of cognitive business processes with applicable knowledge and intelligence;

FIG. 7 is a flow chart illustrating a second exemplary embodiment of the invention;

FIG. 8 is a flow chart illustrating a Sales Effectiveness System (SES) process in accordance with the second exemplary invention;

FIG. 9 is a flow chart illustrating an analysis section of SES;

FIG. 10 is a flow chart illustrating a strategy section of the SES;

FIG. 11 is a flow chart illustrating a plan development section of the SES;

FIG. 12 is a flow chart illustrating a tracking section of the SES;

FIG. 13 is a flow chart illustrating a management section of the SES; and

FIG. 14 is a block diagram of a computer system for implementing the first and second embodiments of the present invention.

### DETAILED DESCRIPTION OF THE INVENTION

In the following detailed description, reference is made to the accompanying drawings, which form a part hereof, and in which is shown by way, of illustration of specific embodiments in which the invention may be practiced. These embodiments are described in sufficient detail to enable those skilled in the art to practice the invention, and it is to be understood that other embodiments may be utilized, and that structural, logical and programming changes may be made without departing from the spirit and scope of the present invention.

Enterprise refers to an organization that will use a Cognitive Business Product (CBP) product for a business transaction.

Company refers to a potential customer that could procure one or more of the Enterprise's products and services.

Lead refers to a person in a Company showing interest in the Enterprise's products and services, which could potentially lead to a sale. A lead is promoted to a contact and an account when the sales objective (defined below) begins to take shape.

Account refers to a Company that has been identified as a potential customer of the Enterprise and has a sale representative assigned to it. Accounts can be of three types:
(1) Strategic accounts generate a significant amount of revenue and typically have a sale representative completely dedicated to it.
(2) Managed accounts generate somewhat lesser revenue and typically do not have a sales representative completely dedicated to it.
(3) Portfolio accounts generate sporadic, one-off revenue and get attention from the Enterprise's sales force only when there is a well-defined sales objective (defined below).

Contact refers to an employee within an account that the Enterprise's sales force has a relationship or needs to develop a relationship. Contacts may or may not be active decision makers in sales objectives (defined below).

Sales Objective refers to an opportunity for the Enterprise to sell one or more of its products and services to an account. Sales objectives are in one of five states:
(1) Identified—when the sales objective is known.
(2) Qualified—when the contacts influencing the sales objective have been contacted and sufficient details are available about the sales objective's scope, context and timeline.
(3) Proposed—when a proposal/quote has been delivered to the account for the Enterprise's products and services.
(4) Won—when the proposal/quote has been accepted and the Enterprise has successfully sold its products and services to the account.
(5) Dead/Lost—when either the proposal/quote has been rejected by the account is favor of that from a competitor or the account has lost interest in the sales objective.

Activity refers to a sales objective and is a specific action that a sales representative should accomplish to advance the sales objective. Examples include communicating with a particular contact, researching an issue, identifying competition, etc. An activity can be in one of two states:
(1) Active—When the activity has been defined, but has not been completed.
(2) Complete—When the activity has been successfully completed by the sales representative.

Order refers to a sales objective that has been converted into a closed deal. The order typically contains the payment amount contractually agreed upon by the Enterprise and the Company, the support arrangements and follow-up items for the Enterprise.

Value refers to any product or service provided by the Enterprise to the Company that improves the Company.

CBP refers to a next generation business process that effectively leverages the Enterprise's knowledge capital and knowledge templates by using the present invention to provide the end-user with insightful knowledge and decision making capabilities.

Knowledge Base refers to knowledge which is represented as Concepts (described below) which is used by the CBP to provide consultation for a given step in a transaction.

Knowledge Engine refers to intelligence which is represented as Inference Rules (described below) which is used by the CBP to formulate strategy and plans for a given step in a transaction as well as an overall strategy and plan.

Concept refers to any unambiguous, natural language notion. Concepts may use a finite number of discrete values.

Inference Rule refers to intelligence that ties Concepts together. Inference Rules may be driven by Stochastic Variables (Fuzzification Rules) or by answers to questions in a Deep Dive (described below).

Knowledge Processor refers to a step in the CBP. A Knowledge Processor may be implemented through a Fuzzy Logic Model that automatically processes Concepts without human intervention.

Deep Dive refers to a step in the CBP. A Deep Dive step may be implemented through an Answer Processing Model which asks an end-user a series of pertinent questions and uses the end-users' answers to further process Concepts.

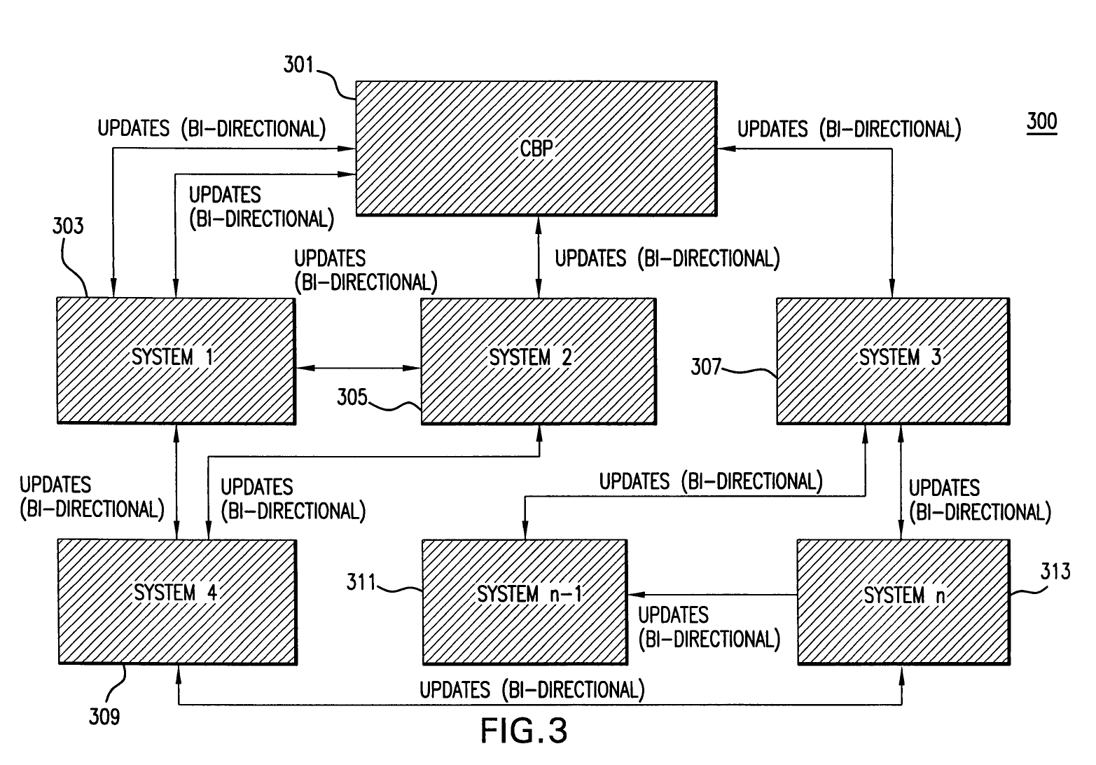

FIG. 3 is a flow diagram of a CBP implemented by the first exemplary embodiment of the present invention. When CBP System 300 receives information from an end user in an Enterprise regarding a matter requiring a business solution, the information is processed by CBP sub-system 301. CBP sub-system 301 communicates with various systems (System 1, System 2, System 3 . . . System n) to obtain information about the matter that should be resolved by CBP System 300 in order to obtain knowledge relevant to the matter. Knowledge may be stored in a Knowledge Base which can be used to provide consultation at each step in order to resolve the matter. Systems 1-n (303, 305, 307, 309, 311 and 313) may be any Enterprise software system. The CBP sub-system 301 updates the various sub-systems and receives updates from the various sub-systems. By receiving updates from the various systems, the CBP sub-system 301 has the ability to learn and adapt to changing situations when resolving the matter.

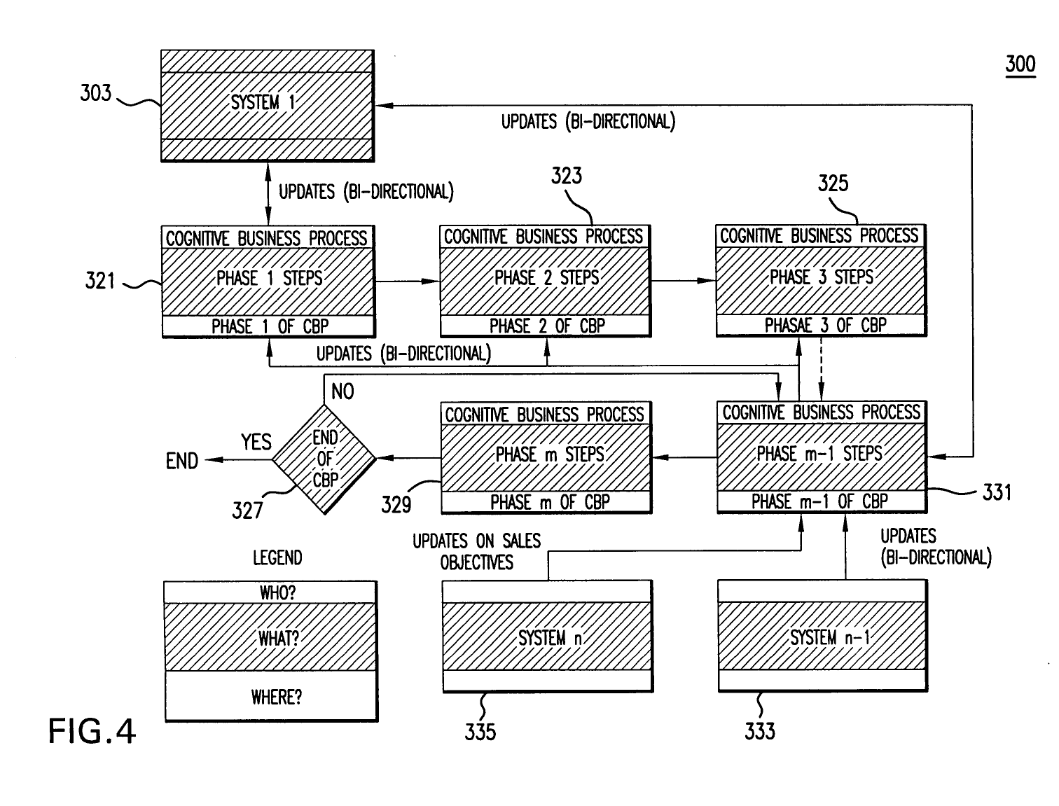

FIG. 4 is a flow diagram of CBP processes by CBP sub-system 301 when resolving a matter posed by System 1 (303). When System 1 (303) sends CBP sub-system 301 information concerning a resolution for a matter, the CBP sub-system 301 conducts various phase steps (Phase step 321, Phase step 323, Phase step 325. Phase step m). Upon completion of the various phase steps, the CBP sub-system 301 determines if the matter has been resolved. If the matter has been resolved, the CBP System 300 outputs resolution data, along with advice and suggestions to be implemented by the end user. If the matter has been resolved, the CBP System 300 will implement another phase step.

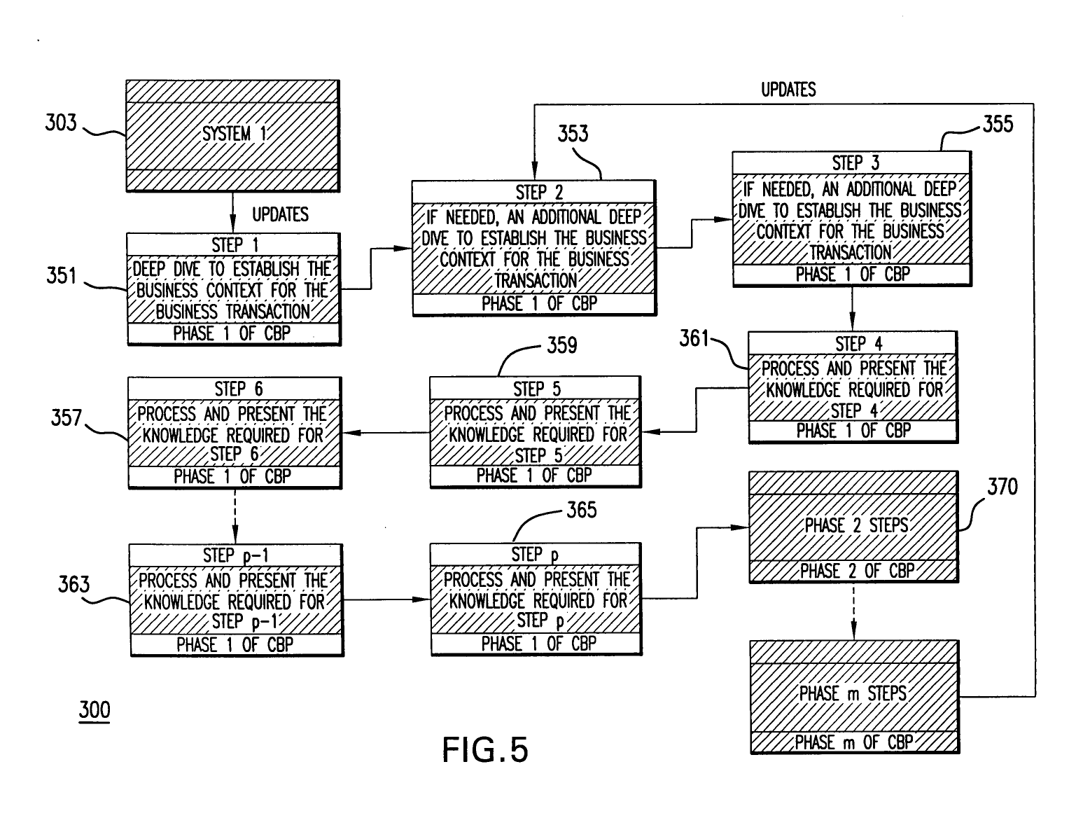

FIG. 5 illustrates sub-steps conducted by Phase step 321. When Phase step 321 receives information about a business transaction, the CBP sub-system 301 uses the information to conduct various sub-steps (351, 353, 355, 357, 359, etc.). In processing the information, the CBP sub-system 301 uses a Knowledge Engine and a Knowledge Base. In order to process the received information, the CBP sub-system 301 conducts a Deep Dive at step 351 to establish a business context for the business transaction. Once the business context has been established, the CBP sub-system 301 processes the information received in light of the business context. Upon completion of processing by the CBP sub-system 301, the CBP system 300 will output advice and suggestions for use by the end user at each step of the business transaction via CBP sub-system 301.

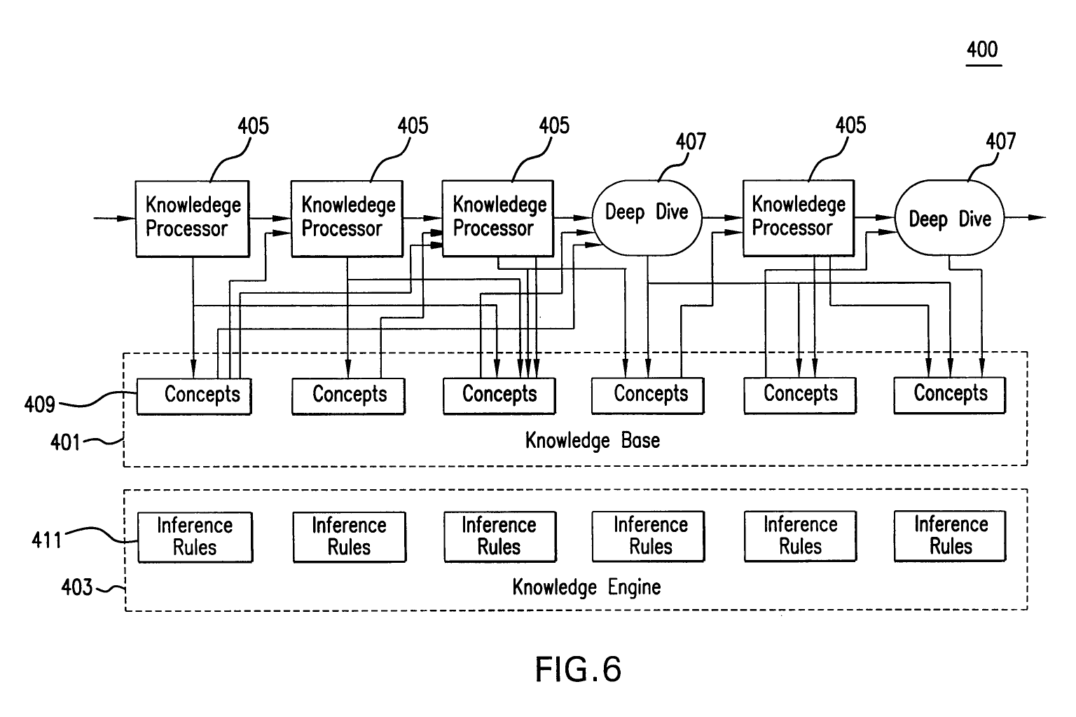

FIG. 6 illustrates processing by the CBP. When CBP System 300 receives information from an end user in an Enterprise regarding a matter requiring a business solution, the information is processed in a Knowledge Processor step 405. The Knowledge Processor 405 uses the information received from the end user and various concepts 409, which reside in a Knowledge Base 401, regarding the matter for which a business solution is being formulated.

At any given step in a CBP, a Deep Dive 407 may be conducted to aid in developing the strategy or plan for use by the end user. During the Deep Dive 407, CBP System 300 prompts the end user to answer a variety of questions based on information received from the end user regarding the matter requiring a business solution. The CBP System 300 uses the answers provided by the end user for adjusting the various strategies and plans for implementing the business solution. Reasons for adjusting the CBP may be, for example, whether or not the matter involves a complex situation, competition in a particular market, what type of value the end user is seeking and the objectives of the Enterprise. Multiple Knowledge Processor 405 and Deep Dive 407 steps may occur during the CBP.

Thus, the CBP process allows an Enterprise to:
(1) Effectively capture, leverage and evolve its latent knowledge assets.
(2) Tightly integrate its knowledge assets with the business processes in all its functional areas.
(3) Provide sophisticated, human-like decision making, reasoning, learning capabilities to identify and apply the relevant knowledge to each step of the business processes for all its functional areas.
(4) Monitor and track the creation, communication, delivery and evolution of value through unambiguous, quantifiable metrics in the business processes for all its functional areas.
(5) Provide a consistent, streamlined and effective framework for assimilating and deploying the Enterprise's knowledge in the form of actionable tasks for the end users of business processes in all its functional areas.
(6) Capture softer aspects of management and conducting business to provide the Enterprise and its customers, suppliers and partners with the capabilities to:
   (a) Become continuously learning and thinking organizations.
   (b) Implement business processes that innovate and not just automate.
   (c) Allow its employees to become specialists in their disciplines.
   (d) Develop a higher-order of intelligence.

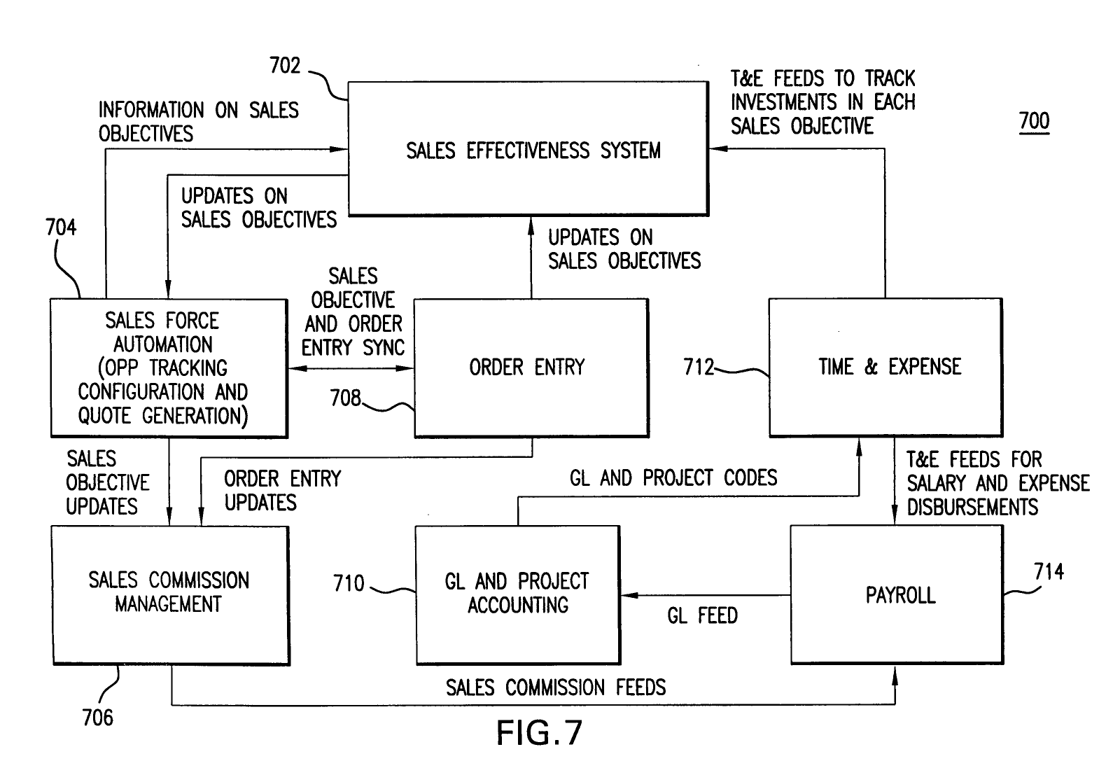

FIG. 7 is a flow diagram for the second exemplary embodiment of the present invention. Sales Enterprise System 700 utilizes a CBP for a sales functional area. When a salesperson receives information regarding a sales objective, the salesperson enters the information into Sales Effectiveness System 702. Subsequently, Sales Effectiveness System 702 updates Sales Force Automation module 704 and Order Entry module 708 with any new information received by the Sales Effectiveness System 702 regarding the sales objective. Sales Force Automation module 704 and Order Entry module 708 communicate with each other to synchronize the sales objective and order information. After Sales Force Automation module 704 provides optimization, consulting and tracking of the sales objective, updated sales objective information is sent to Sales Commission management module 706 for commission processing. Updated order information is also sent to Sales Commission management module 706 by Order Entry module 708. Sales Commission management module 706 sends commission information to Payroll module 714 for processing. Payroll module 714 sends general ledger (GL) information regarding the commission information to GL and Project Accounting module 710 for processing and code generation. GL and Project Accounting module 710 forwards the generated codes to Time & Expense module 712 for processing. Subsequently, Time & Expense module 712 sends Payroll module 714 information concerning necessary disbursements.

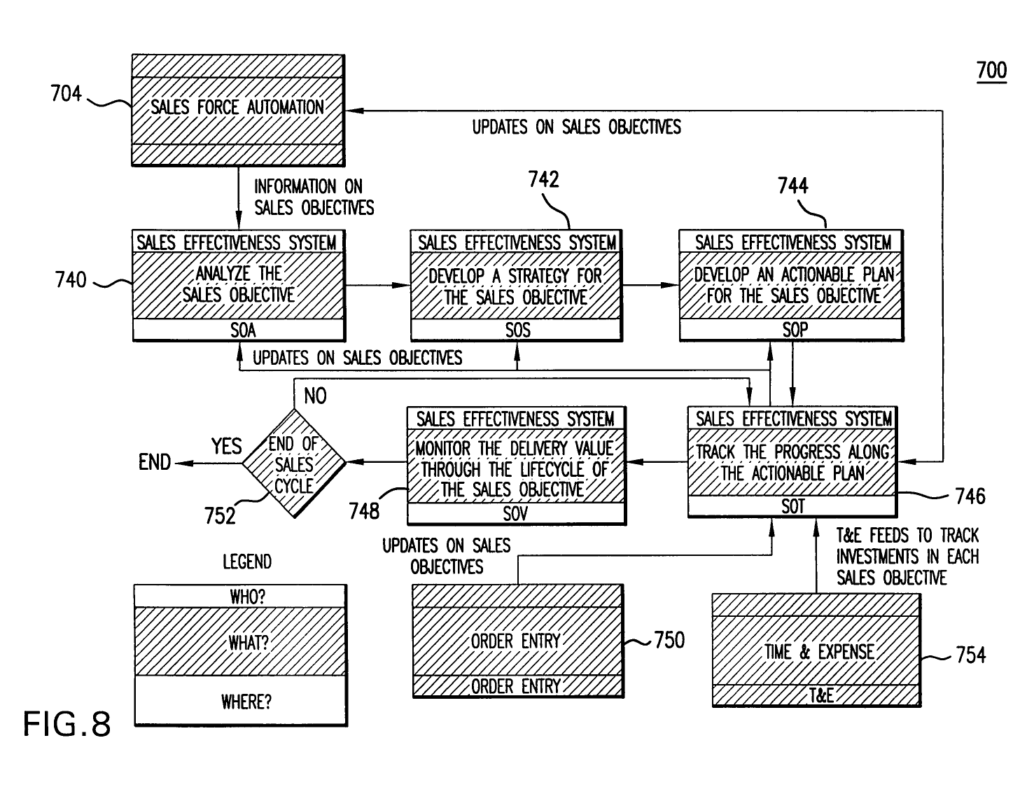

FIG. 8 illustrates an exemplary process flow for Sales Effectiveness System module 702. Upon receipt of a sales objective at step 740, Sales Effectiveness System module 702 will analyze the sales objective. Subsequently, at step 742, the Sales Effectiveness System module 702 will develop a strategy for the particular sales objective. Next, at step 744, based on the determined strategy, Sales Effectiveness System module 702 develops a plan for obtaining an order. Next, at step 746, the Sales Effectiveness System module 702 tracks the sales objective based on the established plan. Next, at step 748, Sales Effectiveness System module 702 monitors value delivered to the Company by the Enterprise throughout the lifecycle of the sales objective.

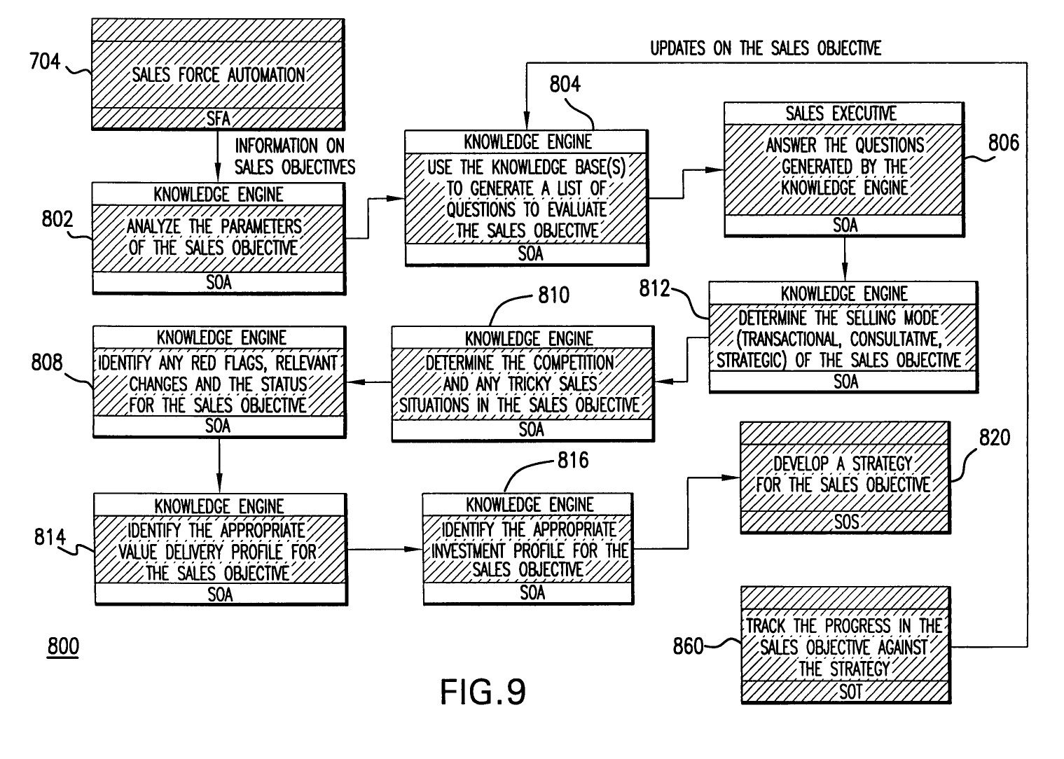

FIG. 9 illustrates the Sales Effectiveness System module's 702 analysis section (740) of the sales objective. When the Sales Effectiveness System module 702 receives information from a salesperson regarding a sales objective, at step 802, the Sales Effectiveness System module 702 uses a Knowledge Engine to analyze parameters associated with the sales objective. At step 804, the knowledge acquires information from the Knowledge Base, which is a repository of information used in a sales industry, to generate a list of questions for use in evaluating the sales objective to be answered by the salesperson. Once the salesperson answers the questions provided by the Knowledge Engine, at step 808, the Knowledge Engine utilizes the answers provided by the salesperson to identify key factors for completing the sales objective in a manner that is mutually beneficial to the Enterprise and Company. At steps 810, 812, 814 and 816, the Knowledge Engine conducts various developmental, determination and identification processes in order to provide an output that could be used to develop a strategy to be used by the Enterprise to obtain an order from the Company. For example, at step 812, based on the information input into the Sales Effectiveness System module 702 and the answers provided by the salesperson, the Knowledge Engine determines which selling mode should used in the analysis of the sales objective.

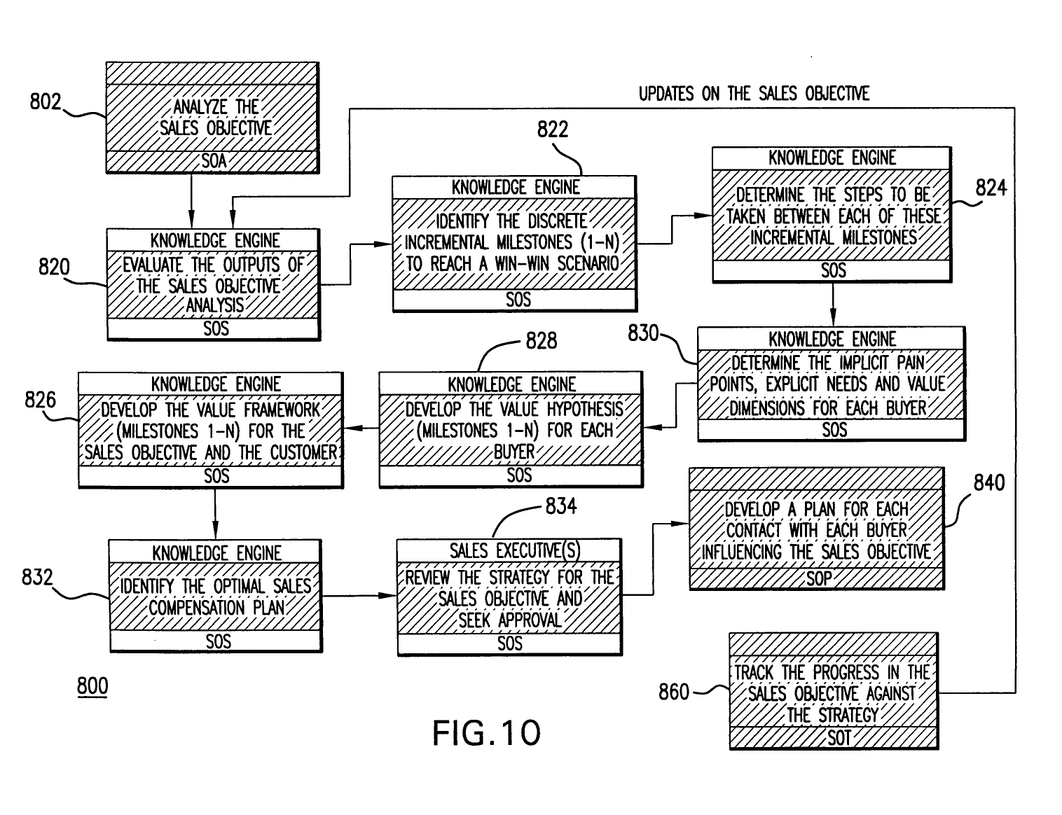

FIG. 10 illustrates the Sales Effectiveness System module's 702 strategy development section (742) for the sales objective. When the Sales Effectiveness System module 702 receives information from the analysis section (740) of the Sales Effectiveness System module 702, at step 820, the Knowledge Engine evaluates information output by the analysis section. At steps 822, 824, 826, 828, 830, 832 and 834, the Knowledge Engine conducts various developmental, determination, identification and review processes in order to provide an output that could be used to develop a strategy to be used by the Enterprise to obtain an order from the Company.

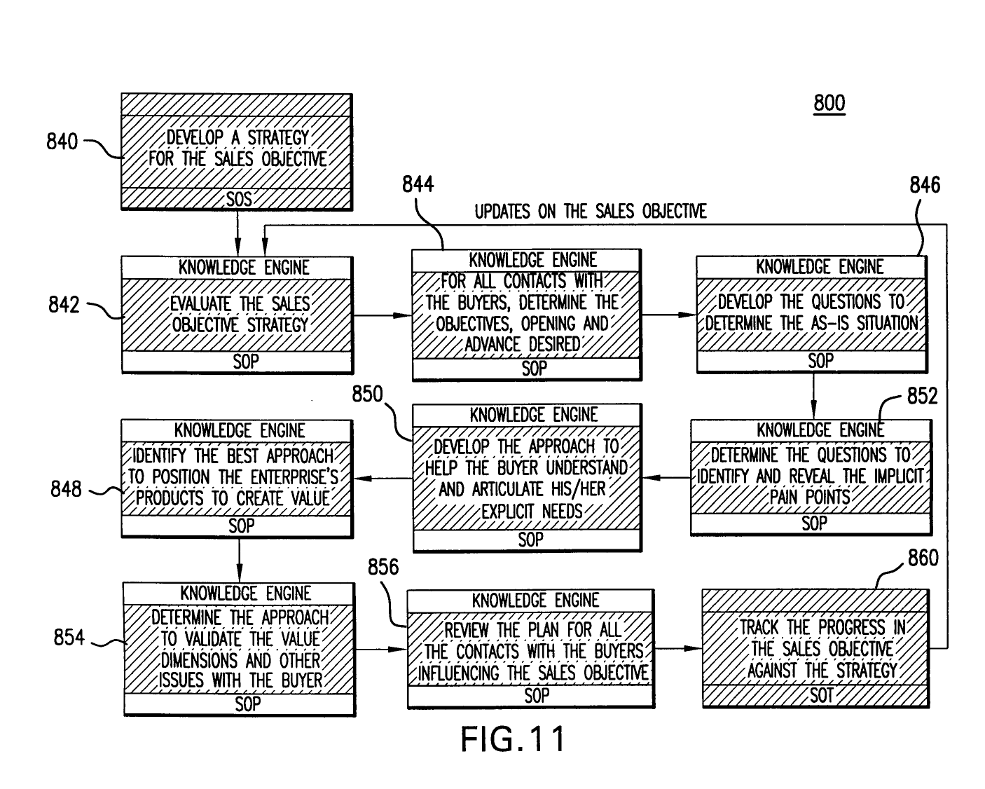

FIG. 11 illustrates the Sales Effectiveness System module's 702 plan development section (744) for the sales objective. When the Sales Effectiveness System module 702 receives information from the strategy section (742) of the Sales Effectiveness System module 702, at step 842, the Knowledge Engine evaluates the sales objective strategy. At step 844, the Knowledge Engine determines needs and objectives for all contacts within the Company, which may influence the sales objective. At step 848, based on the information acquired at step 844 and the information received from the Knowledge Base, the Knowledge Engine identifies a best approach in positioning the Enterprises' products to provide value for the Company. At step 850, based on information acquired at step 844 and information received from the Knowledge Base, the Knowledge Engine develops an approach to assist the Company understand their particular needs. At steps 846, 852, 854 and 856, the Knowledge Engine conducts various developmental, determination and review processes in order to provide an output that could be used to develop a plan to be used by the Enterprise to obtain an order from the Company.

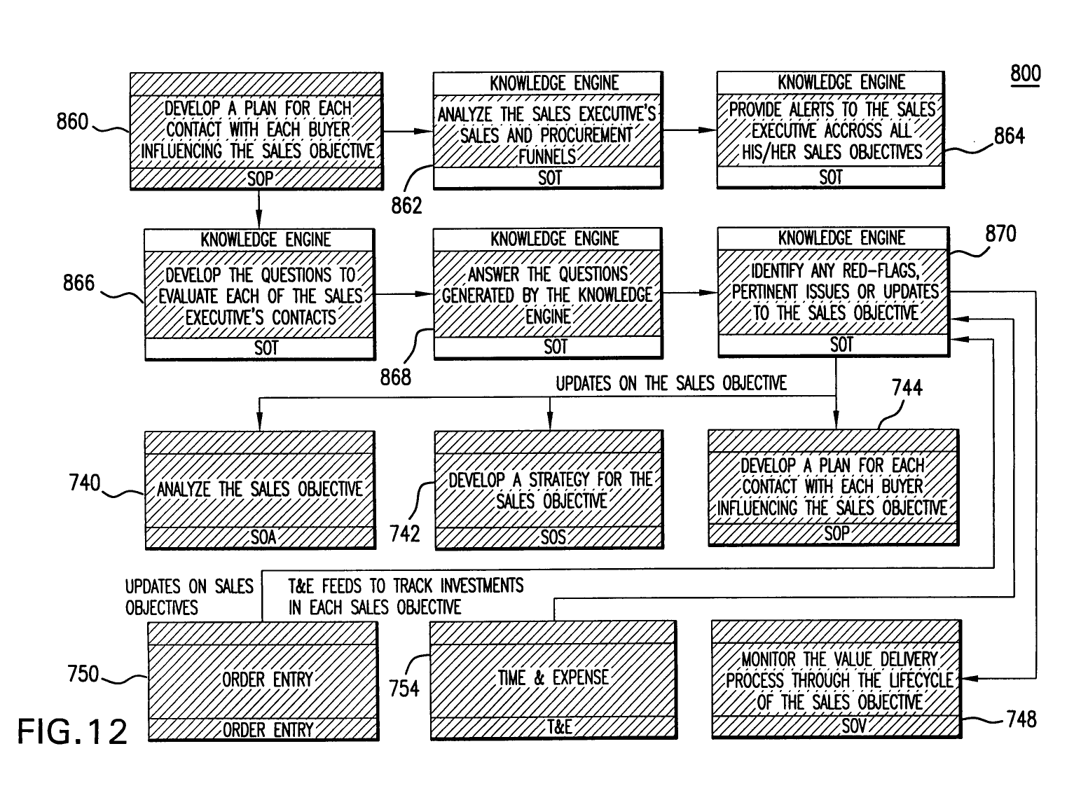

FIG. 12 illustrates the Sales Effectiveness System module's 702 plan tracking section (746) for the sales objective. When the Sales Effectiveness System module 702 receives information from the plan development section (744) of the Sales Effectiveness System module 702, at step 866, the Knowledge Engine develops questions that are used to evaluate a sales executive's activities. Based on answers to these questions, at step 866, the Knowledge Engine tracks progress of the sales objective. At steps 862, 864 and 870, the Knowledge Engine conducts various identification, analysis and alert processes in order to track the progress of the sales objective versus the strategy and plan developed by the Knowledge Engine for use by the Enterprise.

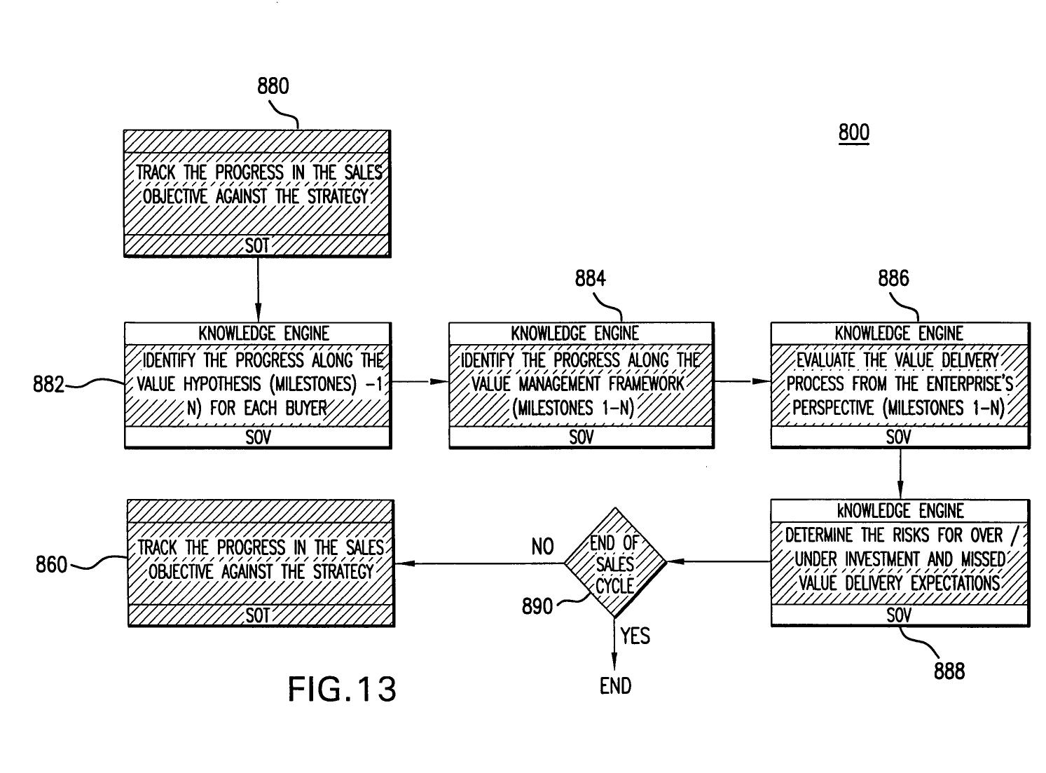

FIG. 13 illustrates the Sales Effectiveness System module's 702 management section (748) for the sales objective. When the Sales Effectiveness System module 702 receives information from the tracking section (744) of the Sales Effectiveness System module 702, at step 882, the Knowledge Engine identifies progress along a milestones diagram having a value hypothesis for the Company. At steps 884, 886, 888 and 892, the Knowledge Engine conducts various identification, evaluation, determination and tracking processes in order to provide an output that could be used to monitor the value delivered to the Company by the Enterprise to be used by the Enterprise to obtain an order and to determine an end of a sales cycle has been accomplished.

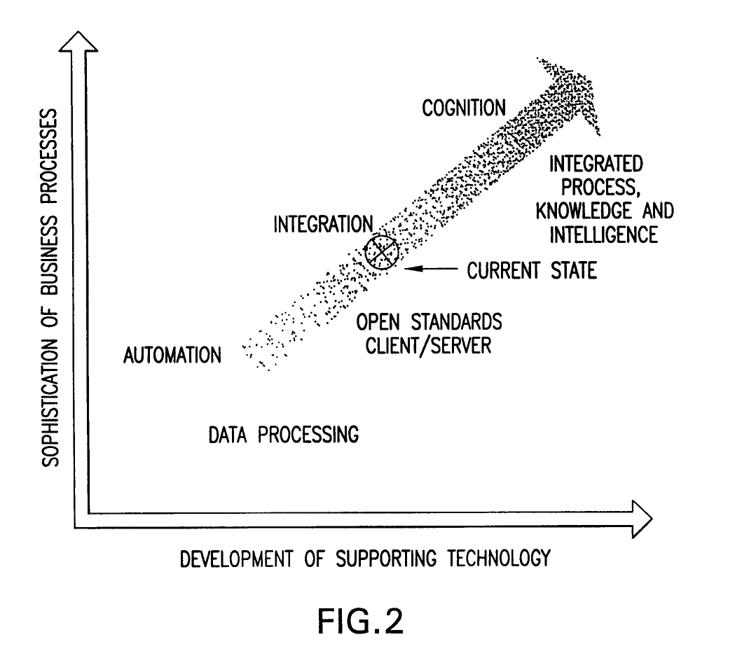

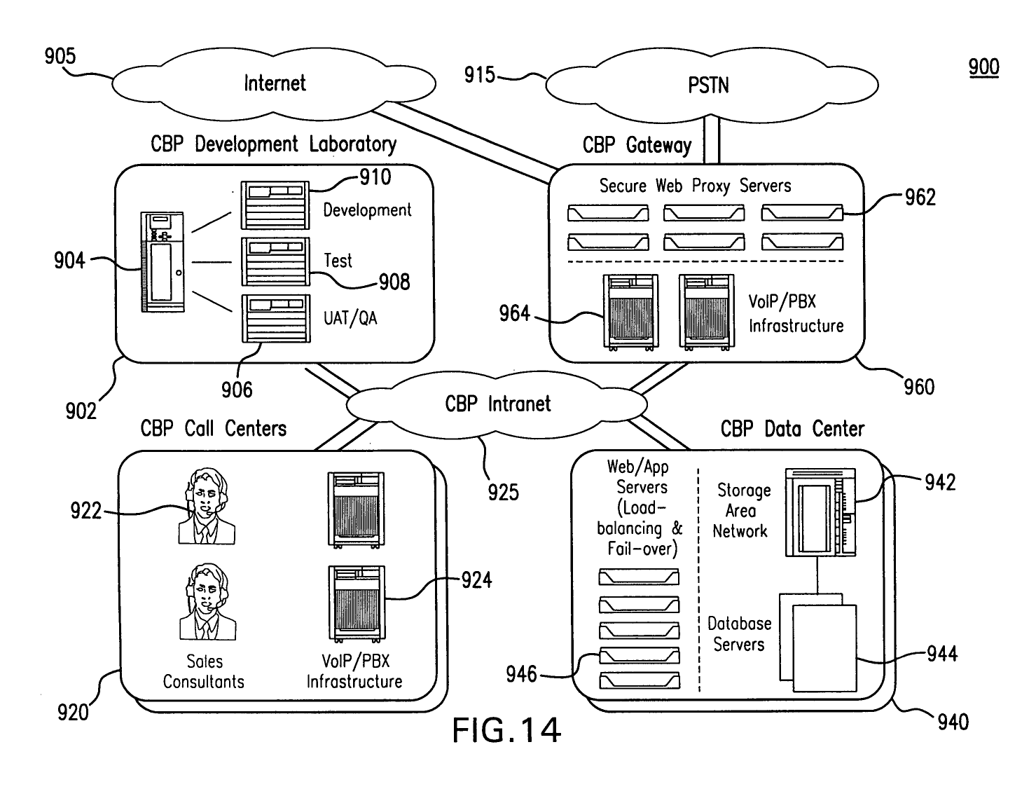

FIG. 14 illustrates an exemplary processing system 900 for implementing the methods in accordance with the embodiments of the present invention disclosed above in FIGS. 2-13. The processing system 900 includes a CBP Development Laboratory 902. The CBP Development Laboratory 902 contains a laboratory system 904, which utilizes user acceptance/quality assurance (UAT/QA) sub-system 906, a test sub-system 908 and a development sub-system 910.

The processing system 900 may include a CBP call center 920. The CBP call center 920 contains a department 922 having one or a plurality of consultants, for example, sales consultants, and a first communications infrastructure 924.

The processing system 900 may include a data center 940. The data center 940 contains a storage area network 942, database servers 944 and web and application servers 946.

The processing system 900 may include a gateway 960. The gateway 960 contains web proxy servers 962 the may be secured and a second communications infrastructure 964. Connected to gateway 960 are the Internet 905 and a public switched telephone network (PSTN) 915. Development Laboratory 902, call center 920, data center 940 and gateway are connected to each other through Intranet 925.

While the invention has been described in detail in connection with exemplary embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. In particular, the specific embodiments of the present invention described should be taken as exemplary and not limiting. For example, the present invention may be used in a web-based application. Accordingly, the invention is not limited by the foregoing description or drawings, but is only limited by the scope of the appended claims.

We claim:

1. A method for implementing a cognitive business process comprising:
using at least one actionable step that constitutes a prospective business transaction;
using a knowledge base and a knowledge engine to determine a business context for the prospective business transaction; and
using the knowledge base and knowledge engine to provide a party with consultation for the at least one actionable step of the prospective business transaction.

2. The method of claim 1, wherein the consultation provides coaching and strategies for the at least one actionable step in the prospective business transaction to be performed by the party.

3. The method of claim 1 further comprising receiving information regarding the prospective business transaction.

4. The method of claim 3, wherein the information is received from an enterprise application.

5. The method of claim 3, wherein the information is received from the party.

6. The method of claim 3, wherein the knowledge base contains the information for a concept that captures the received information.

7. The method of claim 6, wherein the knowledge base contains information on a value that can be assigned to the concept.

8. The method of claim 3, wherein the knowledge engine contains an artificial intelligence rule for mapping incoming information to a concept.

9. The method of claim 3, wherein the knowledge engine contains an artificial intelligence rule for mapping incoming information to a value associated with a concept.

10. The method of claim 3, wherein the knowledge engine contains an artificial intelligence rule for assigning a truth factor to a concept.

11. The method of claim 1 further comprising providing information regarding the prospective business transaction to the party.

12. The method of claim 11, wherein information is provided to an enterprise application.

13. The method of claim 11, wherein information is provided to the party.

14. The method of claim 11, wherein the knowledge base contains information for a concept that captures data to be output to the party.

15. The method of claim 14, wherein the knowledge base contains information on a value that can be assigned to the concept.

16. The method of claim 11, wherein the knowledge engine contains an artificial intelligence rule for mapping a concept to outgoing data.

17. The method of claim 11, wherein the knowledge engine contains an artificial intelligence rule for mapping a value assigned to a concept to outgoing data.

18. The method of claim 11, wherein the knowledge engine contains an artificial intelligence rule for mapping a truth factor assigned to a concept to outgoing data.

19. The method of claim 1, wherein the business context of the prospective business transaction includes at least one concept.

20. The method of claim 1, wherein the knowledge base contains information on at least one concept.

21. The method of claim 20, wherein the at least one concept is associated with the at least one actionable step of the cognitive business process.

22. The method of claim 20, wherein the knowledge base contains information on values that the at least one concept may be assigned.

23. The method of claim 22, wherein the at least one concept is assigned a value having a truth factor.

24. The method of claim 23, wherein the truth factor for the at least one concept varies between a minimum and a maximum threshold.

25. The method of claim 20, wherein the at least one concept has a truth factor threshold.

26. The method of claim 25, wherein the at least one concept uses a number of values each having truth factors equal to or exceeding the truth factor threshold for the at least one concept.

27. The method of claim 1, wherein the knowledge base contains at least one potential question to ask the party to determine the business context of the prospective business transaction.

28. The method of claim 27, wherein the knowledge base contains at least one answer to the at least one potential question.

29. The method of claim 27, wherein the at least one potential question is associated with the at least one actionable step of the cognitive business process.

30. The method of claim 1, wherein the knowledge base stores information for an industry from the group consisting of:
Airline,
Automotive,
Chemical,
Communications,
Consumer Goods and Services,
Electronics and High Technology,
Energy,
Financial Services—Insurance,
Financial Services—Banking,
Financial Services—Capital Markets,
Forest Products,
Freight and Logistics,
Government—Federal,
Government—State,
Government—Local,
Health and Life Sciences—Health Services,
Health and Life Sciences—Medical Products,
Health and Life Sciences—Pharmaceuticals,
Industrial Equipment,
Media and Entertainment,
Metals and Mining,
Rail,
Retail,
Travel Services, and
Utilities.

31. The method of claim 1, wherein the knowledge base stores information for a functional area from the group consisting of:
After-sales support,
Billing,
Business development,
Business intelligence,
Corporate strategy,
Customer and partner relationship management,
Customer care,
Financial management,
General management,
Human resources,
Industry specific back-office functions,
Industry specific front-office functions,
Intellectual property,
Internal Audit,
Investor relations,
IT operations and strategy,
Legal, regulatory and government affairs,
Marketing,
Pre-sales support,
Procurement,
Product development,
Product management and strategy,
Sales,
Security,
Strategic planning, and
Supply chain management.

32. The method of claim 1, wherein the knowledge engine uses artificial intelligence.

33. The method of claim 32, wherein the knowledge engine uses the artificial intelligence to consider incomplete information about the prospective business transaction.

34. The method of claim 32, wherein the knowledge engine uses the artificial intelligence to consider incomplete information about the business context of the prospective business transaction.

35. The method of claim 32, wherein the knowledge engine uses the artificial intelligence to consider incomplete information about the at least one actionable step of the prospective business transaction.

36. The method of claim 1, wherein the knowledge engine stores information on artificial intelligence rules.

37. The method of claim 36, wherein each artificial intelligence rule assigns a truth factor to a first concept having a first value based on a truth factor from a second concept.

38. The method of claim 36, wherein the knowledge engine contains an artificial intelligence rule that is associated with the at least one actionable step of the prospective business transaction.

39. The method of claim 36, wherein the knowledge engine contains an artificial intelligence rule that is associated with at least one concept stored in the knowledge base.

40. The method of claim 36, wherein the knowledge engine contains an artificial intelligence rule that is associated with a value that a concept may be assigned.

41. The method of claim 1, wherein the knowledge engine identifies at least one concept in the knowledge base that is applicable to the at least one actionable step of the prospective business transaction.

42. The method of claim 1, wherein the knowledge engine generates a list of questions to determine the business context of the prospective business transaction.

43. The method of claim 42, wherein answers to the questions are provided by the party.

44. The method of claim 43, wherein based on the answers, the knowledge engine determines the business context of the prospective business transaction.

45. The method of claim 43, wherein based on the answers, the knowledge engine assigns a truth factor to a concept stored in the knowledge base.

46. The method of claim 1, wherein the knowledge engine accepts information about knowledge and patterns of behavior about an execution of the business transaction from the party.

47. The method of claim 46, wherein the received information is used by the knowledge engine in a learning process.

48. The method of claim 47, wherein the learning process updates the knowledge base and knowledge engine.

49. The method of claim 1, wherein the knowledge engine accepts data from an enterprise application.

50. The method of claim 1, wherein the knowledge engine uses information about an industry from the group consisting of:
Airline,
Automotive,
Chemical,
Communications,
Consumer Goods and Services,
Electronics and High Technology,
Energy,
Financial Services—Insurance,
Financial Services—Banking,
Financial Services—Capital Markets,
Forest Products,
Freight and Logistics,
Government—Federal,
Government—State,
Government—Local,
Health and Life Sciences—Health Services,
Health and Life Sciences—Medical Products,
Health and Life Sciences—Pharmaceuticals,
Industrial Equipment,
Media and Entertainment,
Metals and Mining,
Rail,
Retail,
Travel Services, and
Utilities.

51. The method of claim 1, wherein the knowledge engine uses information about a functional area from the group consisting of:
After-sales support,
Billing,
Business development,
Business intelligence,
Corporate strategy,
Customer and partner relationship management,
Customer care,
Financial management,
General management,
Human resources,
Industry specific back-office functions,
Industry specific front-office functions,
Intellectual property,
Internal Audit,
Investor relations,
IT operations and strategy,
Legal, regulatory and government affairs,
Marketing,
Pre-sales support,
Procurement,
Product development,
Product management and strategy,
Sales,
Security,
Strategic planning, and
Supply chain management.

52. A computer based medium, comprising: an application being executable by a computer, wherein the computer executes the steps of:
using at least one actionable step that constitutes for a prospective business transaction;
using a knowledge base and a knowledge engine to determine a business context for the prospective business transaction; and
using the knowledge base and knowledge engine to provide a party with consultation for the at least one actionable step of the prospective business transaction.

53. The computer based medium of claim 52, wherein the consultation provides coaching and strategies for the at least one actionable step in the prospective business transaction to be performed by the party.

54. The computer based medium of claim 52 further comprising receiving information regarding the prospective business transaction.

55. The computer based medium of claim 54, wherein the information is received from an enterprise application.

56. The computer based medium of claim 54, wherein the information is received from the party.

57. The computer based medium of claim 54, wherein the knowledge engine contains an artificial intelligence rule for mapping incoming information to a concept.

58. The computer based medium of claim 52 further comprising providing information regarding the prospective business transaction to the party.

59. The computer based medium of claim 58, wherein information is provided to an enterprise application.

60. The computer based medium of claim 58, wherein information is provided to the party.

61. The computer based medium of claim 58, wherein the knowledge engine contains an artificial intelligence rule for mapping a concept to outgoing data.

62. The computer based medium of claim 52, wherein the business context of the prospective business transaction includes at least one concept.

63. The computer based medium of claim 52, wherein the knowledge base contains information on at least one concept.

64. The computer based medium of claim 52, wherein the knowledge base contains at least one potential question to ask the party to determine the business context of the prospective business transaction.

65. The computer based medium of claim 64, wherein the knowledge base contains at least one answer to the at least one potential question.

66. The computer based medium of claim 64, wherein the at least one potential question is associated with the at least one actionable step of the cognitive business process.

67. The computer based medium of claim 52, wherein the knowledge base stores information for an industry from the group consisting of:
Airline,
Automotive,
Chemical,
Communications,
Consumer Goods and Services,
Electronics and High Technology,
Energy,
Financial Services—Insurance,
Financial Services—Banking,
Financial Services—Capital Markets,
Forest Products,
Freight and Logistics,
Government—Federal,
Government—State,
Government—Local,
Health and Life Sciences—Health Services,
Health and Life Sciences—Medical Products,
Health and Life Sciences—Pharmaceuticals,
Industrial Equipment,
Media and Entertainment,
Metals and Mining,
Rail,
Retail,
Travel Services, and
Utilities.

68. The computer based medium of claim 52, wherein the knowledge base stores information for a functional area from the group consisting of:
After-sales support,
Billing,
Business development,
Business intelligence,
Corporate strategy,
Customer and partner relationship management,
Customer care,
Financial management,
General management,
Human resources,
Industry specific back-office functions,
Industry specific front-office functions,
Intellectual property,
Internal Audit,
Investor relations,
IT operations and strategy,
Legal, regulatory and government affairs,
Marketing,
Pre-sales support,
Procurement,
Product development,
Product management and strategy,
Sales,
Security,
Strategic planning, and
Supply chain management.

69. The computer based medium of claim 52, wherein the knowledge engine uses artificial intelligence.

70. The computer based medium of claim 69, wherein the knowledge engine uses the artificial intelligence to consider incomplete information about the prospective business transaction.

71. The computer based medium of claim 69, wherein the knowledge engine uses the artificial intelligence to consider incomplete information about the business context of the prospective business transaction.

72. The computer based medium of claim 69, wherein the knowledge engine uses the artificial intelligence to consider incomplete information about the at least one actionable step of the prospective business transaction.

73. The computer based medium of claim 52, wherein the knowledge engine stores information on artificial intelligence rules.

74. The computer based medium of claim 73, wherein the knowledge engine contains an artificial intelligence rule that is associated with the at least one actionable step of the prospective business transaction.

75. The computer based medium of claim 73, wherein the knowledge engine contains an artificial intelligence rule that is associated with at least one concept stored in the knowledge base.

76. The computer based medium of claim 73, wherein the knowledge engine contains an artificial intelligence rule that is associated with a value that a concept may be assigned.

77. The computer based medium of claim 52, wherein the knowledge engine identifies at least one concept in the knowledge base that is applicable to the at least one actionable step of the prospective business transaction.

78. The computer based medium of claim 52, wherein the knowledge engine generates a list of questions to determine the business context of the prospective business transaction.

79. The computer based medium of claim 78, wherein answers to the questions are provided by the party.

80. The computer based medium of claim 79, wherein based on the answers, the knowledge engine determines the business context of the prospective business transaction.

81. The computer based medium of claim 52, wherein the knowledge engine accepts information about knowledge and patterns of behavior about an execution of the business transaction from the party.

82. The computer based medium of claim 81, wherein the received information is used by the knowledge engine in a learning process.

83. The computer based medium of claim 82, wherein the learning process updates the knowledge base and knowledge engine.

84. The computer based medium of claim 52, wherein the knowledge engine accepts data from an enterprise application.

85. The computer based medium of claim 52, wherein the knowledge engine uses information about an industry from the group consisting of:
Airline,
Automotive,
Chemical,
Communications,
Consumer Goods and Services,
Electronics and High Technology,
Energy,
Financial Services—Insurance,
Financial Services—Banking,
Financial Services—Capital Markets,
Forest Products,
Freight and Logistics,
Government—Federal,
Government—State,
Government—Local,
Health and Life Sciences—Health Services,
Health and Life Sciences—Medical Products,
Health and Life Sciences—Pharmaceuticals,
Industrial Equipment,
Media and Entertainment,
Metals and Mining,
Rail,
Retail,
Travel Services, and
Utilities.

86. The computer based medium of claim 52, wherein the knowledge engine uses information about a functional area from the group consisting of:
After-sales support,
Billing,
Business development,
Business intelligence,
Corporate strategy,
Customer and partner relationship management,
Customer care,
Financial management,
General management,
Human resources,
Industry specific back-office functions,
Industry specific front-office functions,
Intellectual property,
Internal Audit,
Investor relations,
IT operations and strategy,
Legal, regulatory and government affairs,
Marketing,
Pre-sales support,
Procurement,
Product development,
Product management and strategy,
Sales,
Security,
Strategic planning, and
Supply chain management.

87. A system for implementing a cognitive business process comprising:
a computer system including a processor for executing computer code; and
an application for execution on the computer system, wherein the computer system, when the application executes the steps of:
using at least one actionable step that constitutes for a prospective business transaction;
using a knowledge base and a knowledge engine to determine a business context for the prospective business transaction; and
using the knowledge base and knowledge engine to provide a party with consultation for the at least one actionable step of the prospective business transaction.

88. The system of claim 87, wherein the consultation provides coaching and strategies for the at least one actionable step in the prospective business transaction to be performed by the party.

89. The system of claim 87 further comprising receiving information regarding the prospective business transaction.

90. The system of claim 89, wherein the information is received from an enterprise application.

91. The system of claim 89, wherein the information is received from the party.

92. The system of claim 89, wherein the knowledge engine contains an artificial intelligence rule for mapping incoming information to a concept.

93. The system of claim 87 further comprising providing information regarding the prospective business transaction to the party.

94. The system of claim 93, wherein information is provided to an enterprise application.

95. The system of claim 93, wherein information is provided to the party.

96. The system of claim 93, wherein the knowledge engine contains an artificial intelligence rule for mapping a concept to outgoing data.

97. The system of claim 87, wherein the business context of the prospective business transaction includes at least one concept.

98. The system of claim 87, wherein the knowledge base contains information on at least one concept.

99. The system of claim 87, wherein the knowledge base contains at least one potential question to ask the party to determine the business context of the prospective business transaction.

100. The system of claim 99, wherein the knowledge base contains at least one answer to the at least one potential question.

101. The system of claim 99, wherein the at least one potential question is associated with the at least one actionable step of the cognitive business process.

102. The system of claim 87, wherein the knowledge base stores information for an industry from the group consisting of:
Airline,
Automotive,
Chemical,
Communications,
Consumer Goods and Services,
Electronics and High Technology,
Energy,
Financial Services—Insurance,
Financial Services—Banking,
Financial Services—Capital Markets,
Forest Products,
Freight and Logistics,
Government—Federal,
Government—State,
Government—Local,
Health and Life Sciences—Health Services,
Health and Life Sciences—Medical Products,
Health and Life Sciences—Pharmaceuticals,
Industrial Equipment,
Media and Entertainment,
Metals and Mining,
Rail,
Retail,
Travel Services, and
Utilities.

103. The system of claim 87, wherein the knowledge base stores information for a functional area from the group consisting of:
After-sales support,
Billing,
Business development,
Business intelligence,
Corporate strategy,
Customer and partner relationship management,
Customer care,
Financial management,
General management,
Human resources,
Industry specific back-office functions,
Industry specific front-office functions,
Intellectual property,
Internal Audit,
Investor relations,
IT operations and strategy,
Legal, regulatory and government affairs,
Marketing,
Pre-sales support,
Procurement,
Product development,
Product management and strategy,
Sales,
Security,
Strategic planning, and
Supply chain management.

104. The system of claim 87, wherein the knowledge engine uses artificial intelligence.

105. The system of claim 104, wherein the knowledge engine uses the artificial intelligence to consider incomplete information about the prospective business transaction.

106. The system of claim 104, wherein the knowledge engine uses the artificial intelligence to consider incomplete information about the business context of the prospective business transaction.

107. The system of claim 104, wherein the knowledge engine uses the artificial intelligence to consider incomplete information about the at least one actionable step of the prospective business transaction.

108. The system of claim 87, wherein the knowledge engine stores information on artificial intelligence rules.

109. The system of claim 108, wherein the knowledge engine contains an artificial intelligence rule that is associated with the at least one actionable step of the prospective business transaction.

110. The system of claim 108, wherein the knowledge engine contains an artificial intelligence rule that is associated with at least one concept stored in the knowledge base.

111. The system of claim 108, wherein the knowledge engine contains an artificial intelligence rule that is associated with a value that a concept may be assigned.

112. The system of claim 87, wherein the knowledge engine identifies at least one concept in the knowledge base that is applicable to the at least one actionable step of the prospective business transaction.

113. The system of claim 87, wherein the knowledge engine generates a list of questions to determine the business context of the prospective business transaction.

114. The system of claim 113, wherein answers to the questions are provided by the party.

115. The system of claim 114, wherein based on the answers, the knowledge engine determines the business context of the prospective business transaction.

116. The system of claim 87, wherein the knowledge engine accepts information about knowledge and patterns of behavior about an execution of the business transaction from the party.

117. The system of claim 116, wherein the received information is used by the knowledge engine in a learning process.

118. The system of claim 117, wherein the learning process updates the knowledge base and knowledge engine.

119. The system of claim 87, wherein the knowledge engine accepts data from an enterprise application.

120. The system of claim 87, wherein the knowledge engine uses information about an industry from the group consisting of:
Airline,
Automotive,
Chemical,
Communications,
Consumer Goods and Services,
Electronics and High Technology,
Energy,
Financial Services—Insurance,
Financial Services—Banking,
Financial Services—Capital Markets,
Forest Products,
Freight and Logistics,
Government—Federal,
Government—State,
Government—Local,
Health and Life Sciences—Health Services,
Health and Life Sciences—Medical Products,
Health and Life Sciences—Pharmaceuticals,
Industrial Equipment,
Media and Entertainment,
Metals and Mining,
Rail,
Retail,
Travel Services, and
Utilities.

121. The system of claim 87, wherein the knowledge engine uses information about a functional area from the group consisting of:
After-sales support,
Billing,
Business development,
Business intelligence,
Corporate strategy,
Customer and partner relationship management,
Customer care,
Financial management,
General management,
Human resources,
Industry specific back-office functions,
Industry specific front-office functions,
Intellectual property,
Internal Audit,
Investor relations,
IT operations and strategy,
Legal, regulatory and government affairs,
Marketing,
Pre-sales support,
Procurement,
Product development,
Product management and strategy,
Sales,
Security,
Strategic planning, and
Supply chain management.

122. A system for implementing a cognitive business process comprising:
means for using at least one actionable step that constitutes a prospective business transaction;
means for using a knowledge base and a knowledge engine to determine business context for the prospective business transaction; and
means for using the knowledge base and knowledge engine to provide a party with consultation for the at least one actionable step of the prospective business transaction.
